(19) United States
(12) Patent Application Publication
(10) Pub. No.: US 2011/0193251 A1
(43) Pub. Date: Aug. 11, 2011

(54) Process Gas Confinement for Nano-Imprinting

(75) Inventors: Ankur Jain, Cedar Park, TX (US); Steven C. Shackleton, Austin, TX (US); Byung-Jin Choi, Austin, TX (US)

(73) Assignee: MOLECULAR IMPRINTS, INC., Austin, TX (US)

(21) Appl. No.: 13/023,246

(22) Filed: Feb. 8, 2011

Related U.S. Application Data
(60) Provisional application No. 61/302,738, filed on Feb. 9, 2010.

(51) Int. Cl. B28B 17/00

(52) U.S. Cl. 264/39; 425/210

(57) ABSTRACT

Gas confinement systems and methods are described. In particular, systems and methods are described that include a barrier that confines purging gas and restricts flow of purging gas to other elements within a nano-lithography system. The barrier can be adjusted to accommodate and/or control desired pressure variations between working and external environments.

### CROSS-REFERENCE TO RELATED APPLICATIONS

The present application claims priority to U.S. Provisional Applications No. 61/302,738 filed Feb. 9, 2010, which is hereby incorporated by reference in its entirety.

### BACKGROUND INFORMATION

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Publication No. 2004/0065976, U.S. Patent Publication No. 2004/0065252, and U.S. Pat. No. 6,936,194, all of which are hereby incorporated by reference herein.

An imprint lithography technique disclosed in each of the aforementioned U.S. patent publications and patent includes formation of a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and a formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer.

### SUMMARY OF INVENTION

Methods and systems are provided for confining purging gas in a nanoimprinting process. In one aspect, systems are provided that include an imprint head having a chuck and a template attached to the chuck, together with a substrate that is spaced apart from the template. A barrier surrounds the imprint head, the barrier having a lower surface that is spaced apart from the substrate. Pressurized gas, which may be pressurized air, is provided between the lower surface of the barrier and the substrate, thereby maintaining a gap distance of between 50 μm to 5 mm between the lower surface of the barrier and the substrate. In another aspect, the barrier is moveably connected to the imprint head. In a yet another aspect, the barrier is moveable relative to the imprint head, allowing for adjustment of the gap distance independent of the imprint head. In other aspects, the barrier may have one or more gas nozzles disposed on the lower surface of the barrier that deliver the pressurized gas.

In further aspects, the barrier may include a sidewall spaced apart from the imprint head so as to define one or more channels between the barrier and the imprint head. Such channels may accommodate venting or evacuation of purging gas. In another aspect, the barrier may include an arm that extends in between the chuck and the substrate. In other aspects, the height of the barrier is at least the combined height of the template and chuck.

In another aspect, purging gas may be provided to the working environment located between the template and the substrate. In a further aspect, the pressurized gas provided at the lower surface of the barrier may be provided at a pressure greater than the pressure of the purging gas.

In yet other aspects, methods for confining purging gas in a nano-imprinting process are provided that include providing an imprint head having a chuck and a template attached to the chuck, and a substrate spaced apart from the template, surrounding the imprint head with a barrier, providing pressurized gas, which may be pressurized air, to maintain the lower surface of the barrier at a gap distance of between 50 μm to 5 mm from the substrate and create a gas barrier between the lower surface and the substrate, and providing purging gas to the working environment between the template and the substrate. In another aspect, the barrier further includes a sidewall spaced apart from the imprint head so as to define one or more channels between the barrier and the imprint head. In yet another aspect, the provided barrier has a height that is at least the combined height of the template and chuck. In further aspects the barrier is moveable relative to the imprint head.

In other aspects, the pressurized gas is provided at a pressure greater than the pressure of the purging gas. In yet other aspects, the purging gas is vented or evacuated through the one or more channels.

Aspects and implementations described herein may be combined in ways other than described above. Other aspects, features, and advantages will be apparent from the following detailed description, the drawings, and the claims.

### BRIEF DESCRIPTION OF DRAWINGS

So that features and advantages of the present invention can be understood in detail, a more particular description of embodiments of the invention may be had by reference to the embodiments illustrated in the appended drawings. It is to be noted, however, that the appended drawings only illustrate typical embodiments of the invention, and are therefore not to be considered limiting of its scope, for the invention may admit to other equally effective embodiments.

FIG. 1 illustrates a simplified side view of a lithographic system.

FIG. 2 illustrates a simplified side view of the substrate illustrated in FIG. 1, having a patterned layer thereon.

FIGS. 3 and 4 illustrate simplified side views of flow of purging gas during an imprinting process.

FIG. 5 illustrates a simplified side view of an exemplary prior art semi-enclosed system.

FIG. 6A illustrates a simplified side view of an exemplary gas confinement system in accordance with the present invention.

FIG. 6B illustrates a simplified top view of the exemplary gas confinement system of FIG. 6A.

### DETAILED DESCRIPTION

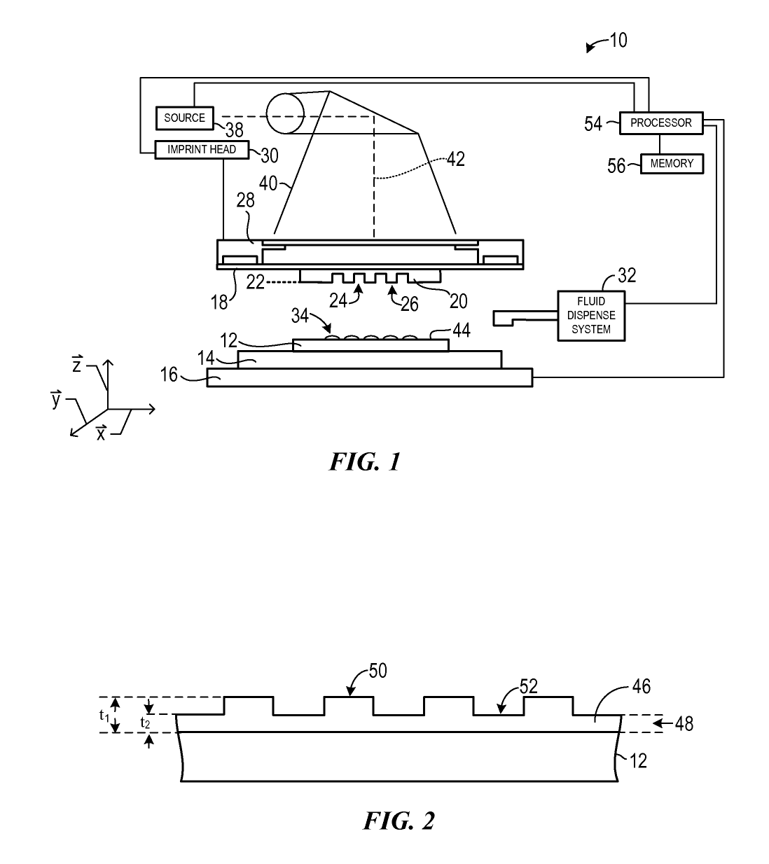

Referring to the figures, and particularly to FIG. 1, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electrostatic, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide translational and/or rotational motion along the x, y, and z-axes. Stage 16, substrate 12, and substrate chuck 14 may also be positioned on a base (not shown).

Spaced-apart from substrate 12 is template 18. Template 18 may include a body having a first side and a second side with one side having a mesa 20 extending therefrom towards substrate 12. Mesa 20 having a patterning surface 22 thereon. Further, mesa 20 may be referred to as mold 20. Alternatively, template 18 may be formed without mesa 20.

Template 18 and/or mold 20 may be formed from such materials including, but not limited to, fused-silica, quartz, silicon, organic polymers, siloxane polymers, borosilicate glass, fluorocarbon polymers, metal, hardened sapphire, and/or the like. As illustrated, patterning surface 22 comprises features defined by a plurality of spaced-apart recesses 24 and/or protrusions 26, though embodiments of the present invention are not limited to such configurations (e.g., planar surface). Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electrostatic, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit formable material 34 (e.g., polymerizable material) on substrate 12. Formable material 34 may be positioned upon substrate 12 using techniques, such as, drop dispense, spin-coating, dip coating, chemical vapor deposition (CVD), physical vapor deposition (PVD), thin film deposition, thick film deposition, and/or the like. Formable material 34 may be disposed upon substrate 12 before and/or after a desired volume is defined between mold 22 and substrate 12 depending on design considerations. Formable material 34 may be functional nano-particles having use within the bio-domain (including e.g., pharmaceuticals and other biomedical applications), solar cell industry, battery industry, and/or other industries requiring a functional nano-particle. For example, formable material 34 may comprise a monomer mixture as described in U.S. Pat. No. 7,157,036 and U.S. Patent Publication No. 2005/0187339, both of which are herein incorporated by reference. Alternatively, formable material 34 may include, but is not limited to, biomaterials (e.g., PEG), solar cell materials (e.g., N-type, P-type materials), and/or the like.

Referring to FIGS. 1 and 2, system 10 may further comprise energy source 38 coupled to direct energy 40 along path 42. Imprint head 30 and stage 16 may be configured to position template 18 and substrate 12 in superimposition with path 42. System 10 may be regulated by processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by formable material 34. For example, imprint head 30 may apply a force to template 18 such that mold 20 contacts formable material 34. After the desired volume is filled with formable material 34, source 38 produces energy 40, e.g., ultraviolet radiation, causing formable material 34 to solidify and/or cross-link conforming to a shape of surface 44 of substrate 12 and patterning surface 22, defining patterned layer 46 on substrate 12. Patterned layer 46 may comprise a residual layer 48 and a plurality of features shown as protrusions 50 and recessions 52, with protrusions 50 having a thickness t₁ and residual layer having a thickness t₂.

The above-mentioned system and process may be further employed in imprint lithography processes and systems referred to in U.S. Pat. No. 6,932,934, U.S. Pat. No. 7,077,992, U.S. Pat. No. 7,179,396, and U.S. Pat. No. 7,396,475, all of which are hereby incorporated by reference in their entirety.

During imprinting as described above, distance between template 18 and substrate 12 may be purged with process gases to eliminate air voids during filling of formable material 34 therebetween. Typically, purging gases have a lower molecular weight as compared to ambient air. Purging the interface between template 18 and substrate 12 is generally necessary prior to filing formable material 34. During purging, however, gases from purging outlets may emit gases into the environment of system 10 and negatively affect elements within system 10. For example, the purging gases may cause errors in the tool control feedback unit 60, leading to registration error during nano-imprinting.

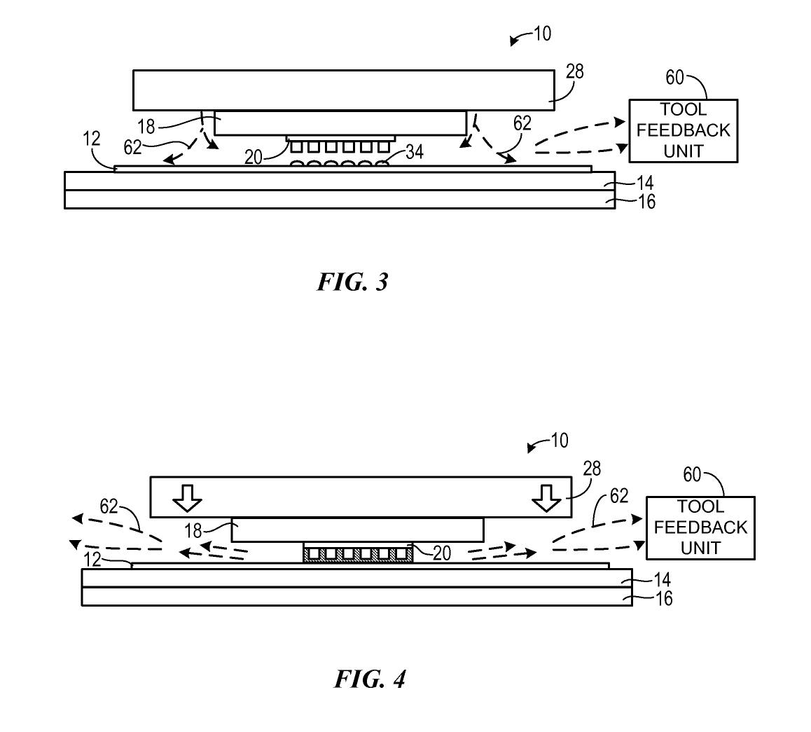

Referring to FIG. 3, system 10 may include a tool control feedback unit 60 (e.g., laser interferometer (IFM) based feedback system) that may be negatively affected by purging gases 62. Generally, tool control feedback unit 60 may require a consistent and stable environment wherein even a small disturbance (e.g., pressure, temperature, index, and the like) may degrade accuracy of readings and lead to error. For example, errors in IFM feedback may provide inaccurate position control of system elements leading to registration error during nano-imprinting.

The design of template 18 may provide for purging ports and/or evacuation ports such as provided in the template disclosed in U.S. Ser. No. 12/987,196 filed Jan. 10, 2011, which is hereby incorporated by reference in its entirety. These schemes generally confine purging gas between template 18 and substrate 12 during purging by evacuating purging gas via channels and ports surrounding the purging area. Purging gas, however, may escape laterally as the gap between template 18 and substrate 12 reduces in distance. For example, as illustrated in FIG. 4, purging gases 62 may escape laterally from interface between template 18 and substrate 12 as the distance between template 18 and substrate 12 is reduced, and negatively impact tool feedback unit 60.

Partial environment imprinting schemes may provide semi-enclosed systems and methods for confining purging gases. Exemplary systems and methods are further described in U.S. Pat. No. 7,670,530, U.S. Publication No. 2010/0112116, and U.S. Pat. No. 7,462,028, which are hereby incorporated by reference in their entirety.

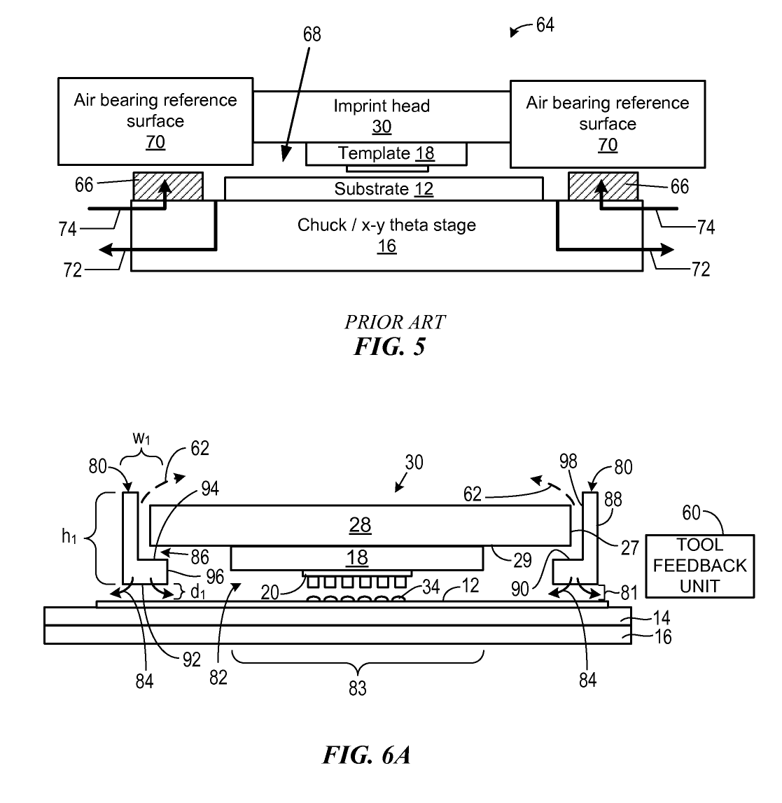

FIG. 5 illustrates an exemplary semi-enclosed system 64. System 64 may provide partial pressure between substrate 12 and template 18. Vacuum preloaded air bearings 66 may substantially seal the working or mini-environment 68 that may be filled with a purging gas having a lower molecular weight as compared to ambient air. Air bearings 66 may be positioned adjacent to plate 70. Channels (not shown) may provide an evacuation 72 from environment 68. Pressurized gas 74 may be channeled through air bearing 68 in a balance of plate 70 and corresponding imprint head 30.

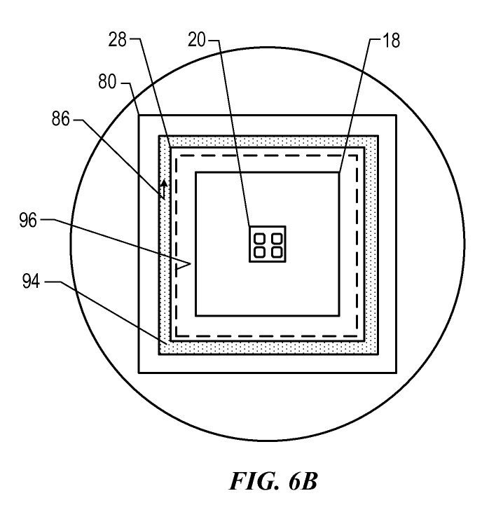

A system using generally similar concepts but with different structural elements providing greater functionality may be used for gas confinement. The system provides for a barrier that confines purging gases in a dynamic fashion, and can be adjusted to accommodate and/or control desired pressure variations between the working and external environments. Referring to FIGS. 6A and 6B, barrier 80 may be provided in a gas confinement system or process. Barrier 80 may be positioned at a distance d₁ from substrate 12 forming a gap 81. Gap distance d₁ may be in the range of approximately 100 μm-5 mm, and in some cases 50 μm-5 mm. For example, the range of distance d₁ may be decreased from 100 μm down to as low as 50 μm, provided fluid dispensing remains substantially unaffected. By maintaining gap 81 between a barrier apparatus 80 and substrate 12 and/or chuck 14 surface at distance d₁, an air barrier may be formed within the gap that that provides for confinement of purging gases within working environment 82. Purging gases may be provided to working environment 82 by channels (not shown) in chuck 28.

Barrier 80 includes body 88 and arm 90 extending from the lower portion of the body. Body 88 and arm 90 include lower surface 92 that is spaced apart from substrate 12 to create gap 81. Arm 90 further includes face 96, and upper surface 94 and sidewall 98 that are spaced apart from surface 29 and edge 27, respectively, of chuck 28, creating channel 86 between barrier 80 and imprint head 30. Channel 86 may be sufficiently wide to provide unrestricted flow of vented or evacuated purging gases. For example, the width of channel 86 may be 1-20 mm.

Barrier 80 may surround imprint head 30, chuck 28 or both. Barrier 80 may also be connected or attached to imprint head 30, chuck 28 or both, while maintaining barrier 80 in a spaced apart position from imprint head 30 and/or chuck 28 in order to retain spacing for channels 86. For example, barrier 80 may be attached by bolting, adhesive, and/or the like. Barrier 80 may also be moveably connected to imprint head 30 and/or chuck 28 or both, such that barrier 80 can translationally move along x and y coordinates with imprint head 30, but imprint head 30 can move up and down independently of barrier 80, allowing barrier 80 to maintain gap distance d₁ during, for example, imprinting. Barrier 80 may include a body having a height h₁ and an overall width w₁. Height h₁ may be at least the height of template 18 and chuck 28. Width w₁ may be a few millimeters to 30 millimeters. It should be noted that width w₁ may vary depending on gap distance d₁ of gap 81. Width w₁ must be large enough relative to gap distance d₁ to ensure that gas intended to be purged from working environment 82 is able to escape through channels 86 and not through gap 81. Generally, the ratio of width w₁ to gap distance d₁ will be at least 10:1, and can be 20:1 or 50:1 or 100:1 or higher.

Barrier 80 may surround substrate 12 and/or field 83 of substrate 12. Field 83 of substrate 12 may be a portion of substrate 12 being imprinted. Barrier 80 as depicted includes arm 90 that extends from body 88 and between chuck 28 and substrate 12. In this particular configuration, the provision of arm 90 between chuck 28 and substrate 12 further increases the fluidic resistance to purging gas escaping from the gap 81. As a result, it aids in improving the gas confinement effect.

As noted, barrier 80 generally may substantially sustain distance d₁ of gap 81 during imprinting of each field of substrate 12. By substantially sustaining gap distance d₁, gas confinement may be provided during imprinting of fields of substrate 12. Gap distance d₁ can be maintained by providing pressurized gas 84 between lower surface 92 of barrier 80 and substrate 12.

Pressurized gas 84 may also form an air barrier, generating a boundary having a higher pressure as compared to that of purging gas in working environment 82. As such, pressurized gas 84 may confine purging gases within environment 82, and the purging gas may be substantially prevented from contacting tool elements, particularly tools located in proximity to working environment 82, such as tool feedback unit 60.

The use of pressurized gas 84 to maintain barrier 80 at gap distance d₁ from substrate 12 is distinct from an air bearing system, such as shown in FIG. 5. Air bearings typically provide an air cushion between two elements at a fixed distance of approximately 10 μm or less. Little to no variation in such distance can be achieved with an air bearing, and thus little to no adjustments can be made to accommodate and/or adjust for or control desired pressure variations. In the system of FIG. 6A-6B, the gap distance d₁ is 5× to 100× that of an air bearing, and adjustable across the entire range.

Barrier 80 may include one or more nozzles providing pressurized gas 84 to maintain gap distance d₁ and/or provide an air barrier for confining purging gases. Nozzle geometry (e.g., number, size, location, spacing, and the like) may be optimized depending on design considerations. Pressure drop, flowrate considerations, geometrical considerations, etc. are some of the parameters upon which the nozzle geometry depends. A computational fluid dynamics (CFD) based simulation may help in optimization of the nozzles. Pressurized gas 84 may be pressurized air, but other pressurized gases may be employed.

As noted, positioning of barrier 80 from template 18 and/or chuck 28 may provide one or more channels 86. Channels 86 may provide an evacuation route for purging gases. Channels 86 provide an evacuation route pulling purging gases substantially away from elements of the imprinting system that may be affected (e.g., IFM beam path). Channels 86 may be active channels and/or passive channels relying on negative pressure differential in evacuation of gases. As depicted, channel 86 is a continuous channel extending around the periphery of chuck 28 and imprint head 30, although it will be readily appreciated that such a channel need not be continuous and that multiple channel configurations, including for example equally spaced holes, can be provided about the periphery of chuck 28 and/or imprint head 30. Additional gas flow channels may be implemented into barrier apparatus 80. Gas flow channels may provide for positive and/or negative flow.

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A system for confining purging gas in a nanoimprinting process, the system comprising:
an imprint head having a chuck and a template attached to the chuck;
a substrate spaced apart from the template and defining a work environment therebetween; and
a barrier surrounding the imprint head, the barrier having a lower surface positioned such that the lower surface is spaced apart from the substrate, and where the barrier provides pressurized gas between the lower surface of the barrier and the substrate, thereby maintaining a gap distance between the lower surface of the barrier and the substrate of between 50 μm to 5 mm.

2. The system of claim 1 wherein the barrier is moveable relative to the imprint head, thereby allowing for adjustment of the gap distance independent of the imprint head.

3. The system of claim 1 wherein the barrier further includes one or more gas nozzles disposed on the lower surface of the barrier that deliver the pressurized gas.

4. The system of claim 1 wherein the barrier further includes a sidewall spaced apart from the imprint head so as to define one or more channels between the barrier and the imprint head.

5. The system of claim 4 wherein the chuck includes a surface facing the substrate, and the barrier includes an arm extending therefrom and between the chuck and the substrate.

6. The system of claim 4 wherein purging gas is provided to the working environment.

7. The system of claim 6 wherein the pressurized gas is provided at a pressure greater than the pressure of the purging gas.

8. The system of claim 6 wherein the purging gas is vented or evacuated through the one or more channels.

9. The system of claim 1 wherein the pressurized gas is air.

10. The system of claim 1 wherein the barrier has a height that is at least the combined height of the template and chuck.

11. The system of claim 2 wherein the barrier is moveably connected to the imprint head.

12. A system for confining purging gas in a nanoimprinting process, the system comprising:
an imprint head having a chuck and a template attached to the chuck;
a substrate spaced apart from the template and defining a work environment therebetween; and
a barrier surrounding the imprint head, the barrier having a sidewall spaced apart from the imprint head so as to define one or more channels between the barrier and the imprint head, and a lower surface positioned such that the lower surface is spaced apart from the substrate, and where the barrier provides pressurized gas between the lower surface of the barrier and the substrate, thereby maintaining a gap distance between the lower surface of the barrier and the substrate of between 50 μm to 5 mm, and where the barrier is moveable relative to the imprint head, allowing for adjustment of the gap distance independent of the imprint head.

13. The system of claim 12 wherein the chuck includes a surface facing the substrate, and the barrier includes an arm extending therefrom and between the chuck and the substrate.

14. A method for confining purging gas in a nanoimprinting process, comprising the steps of:
(a) providing an imprint head having a chuck and a template attached to the chuck, and a substrate spaced apart from the template and defining a work environment therebetween;
(b) surrounding the imprint head with a barrier, the barrier having a lower surface spaced apart from the substrate;
(c) providing pressurized gas to maintain the lower surface at a gap distance of between 50 μm to 5 mm from the substrate and create a gas barrier between the lower surface and the substrate; and
(d) providing purging gas to the working environment.

15. The method of claim 14 wherein the provided barrier is moveable relative to the imprint head.

16. The method of claim 14 wherein the provided barrier further includes a sidewall spaced apart from the imprint head so as to define one or more channels between the barrier and the imprint head.

17. The method of claim 14 wherein the pressurized gas is provided at a pressure greater than the pressure of the purging gas.

18. The method of claim 14 further comprising the step of venting or evacuating the purging gas through the one or more channels.

19. The method of claim 14 wherein the pressurized gas is air.

20. The method of claim 14 wherein the provided barrier has a height that is at least the combined height of the template and chuck.
